(19) United States
(12) Patent Application Publication
(10) Pub. No.: US 2016/0187161 A1
(43) Pub. Date: Jun. 30, 2016

(54) SENSOR AND METHOD FOR DETECTING A POSITION IN TWO SPATIAL DIRECTIONS

(71) Applicant: ZF FRIEDRICHSHAFEN AG, Friedrichshafen (DE)

(72) Inventors: Thomas LUBER, Hahnbach (DE); Hans-Ludwig GÖTZ, Hahnbach (DE)

(73) Assignee: ZF Friedrichshafen AG, Friedrichshafen (DE)

(21) Appl. No.: 14/911,178

(22) PCT Filed: Jul. 14, 2014
(86) PCT No.: PCT/EP2014/065022

§ 371 Date: Feb. 9, 2016

(30) Foreign Application Priority Data
Aug. 13, 2013 (DE) 10 2013 215 947.1

(51) Int. Cl. G01D 5/20

(52) U.S. Cl. CPC G01D 5/2006

(57) ABSTRACT

Sensor for detecting a position in two spatial directions (x, y), wherein the sensor comprises a sensor array and an actuator. The sensor array has a first row and at least a second row. The rows have in a first spatial direction (x) adjacently arranged sensor elements. The rows are arranged side by side in a second spatial direction (y) transverse to the first spatial direction (x). The actuator is arranged in a third spatial direction (z) transverse to the first spatial direction (x) and the second spatial direction (y) spaced apart from the sensor array. The actuator is designed movable in the first spatial direction (x) and the second spatial direction (y) relative to the sensor array. The actuator is adapted to influence a measurement variable of the sensor elements, wherein a signal of a sensor element represents a degree of overlap of the sensor element by the actuator.

The present disclosure relates to a sensor for detecting a position in two spatial directions, to a method for detecting a position of an actuator of a sensor in two spatial directions, to a corresponding device and to a corresponding computer program product.

A relative position of two arranged components movable relatively to each other can be measured without contact. For example, the relative position can be detected inductively.

DE 10 2007 015 524 A1 describes a method for producing an inductive damping element and an inductive eddy current actuator.

Against this background, the present disclosure provides an improved sensor for detecting a position in two spatial directions, an improved method for detecting a position of an actuator of a sensor in two spatial directions, a correspondingly improved apparatus and a correspondingly improved computer program product according to the independent claims. Advantageous embodiments result from the dependent claims and the following description.

Sensor elements in a row can detect a position of a counterpart along the row. The position can be determined by an algorithm also at positions between the sensor elements. With at least two adjacent rows of the sensor elements, the position can also be resolved transverse to the rows.

By at least two rows of sensor elements, a sensor can detect the position of the actuator in two dimensions. By the extended detection area, two spatial directions can be detected at once with a single sensor. A sensor for detecting a position in two spatial directions comprises the following features: a sensor array having a first row and at least a second row, said rows having in a first spatial direction adjacently arranged sensor elements, and the rows are arranged side by side in a second spatial direction transverse to the first spatial direction; and an actuator arranged at a distance from the sensor array in a third spatial direction transverse to the first and second spatial directions which is designed to be movable relatively to the sensor array, wherein the actuator is adapted to influence a measured variable of the sensor elements wherein a signal of a sensor element represents a degree of overlap of the sensor element by the actuator.

Such a sensor can be understood to be a non-contact sensor. For example, the sensor can operate based on induction, magnetism, electrostatics or photoelectricity. A sensor element can have a sensor surface, based on which the signal is generated. A sensor element can comprise a passive edge. The sensor elements of a row can be located immediately adjacent to each other. The sensor elements of a row can also be arranged spaced apart. An actuator can have an active surface that is aligned substantially parallel to the sensor surface of the sensor elements. A signal can be an electrical signal. The signal may be analog or digital. An overlap can be a degree of coverage of a sensor element by the actuator.

An intermediate space may be arranged between the first row and the second row. Due to the intermediate space, the signal of the sensor elements of the first row can differ from the stronger signal of the sensor elements of the second row. This can result in an improved detection of a motion in the second spatial direction.

The second row may have fewer sensor elements than the first row. The second row can be shorter than the first row. With fewer sensor elements, unused sensor elements can be avoided.

The sensor elements can be of the same size. With a similar type of structure of the sensor elements, manufacturing cost can be reduced.

The actuator may be movable on a first path, at least a second path and a connecting path, wherein the first path at least partially extends in the area of the first row, the second path extends at least partially in the area of the second row and the connecting path connects the first path with the second path. Due to a guide on the paths, intermediate positions between the paths, other than on the connecting path, can be excluded. Due to this, any errors in the sensor can be easily detected because positions outside the paths are not allowed. Even the measurement accuracy can be increased because the paths are linearly extending in the first spatial direction, and the position in the second spatial direction is detected only on the connecting path.

The first path and/or the second path can be curved, wherein the sensor array is curved at least in one spatial direction. By a curvature, the distance between the actuator and the sensor array can be maintained within a predetermined tolerance.

The actuator can comprise an electrically conductive material and/or the sensor elements can be formed as sensor coils, wherein in particular, the actuator can be separated by an air gap from the sensor array and/or can be adapted to reduce the inductance of the sensor coils by the overlap, and the reduced inductance is displayed in the signal. By the inductive detection of the position, the actuator can be designed without electrical contact. The actuator can be purely passive. Thereby, the construction of the sensor can be simplified.

The actuator can comprise a first sub-area and at least one second sub-area, wherein the first sub-area and the second sub-area are arranged fixed to each other and a first centroid of the first sub-area is arranged spaced from a second centroid of the second sub-area. The sub-areas can have functional geometries. The geometries can be different. Due to various sub-areas, the signals of the sensor elements can represent the position of the actuator in greater detail.

The sensor array can comprise in the second spatial direction next to the second row at least one further row of sensor elements adjacently arranged in the first spatial direction. The rows can form a matrix. By a matrix, a large detection range can be achieved.

A method for detecting a position of an actuator of a sensor in two spatial directions, wherein the sensor comprises a sensor array and an actuator, wherein the sensor array comprises a first row and at least a second row, which comprise in a first spatial direction adjacent planar sensor elements and are arranged next to one another in a second spatial direction transverse to the first spatial direction, wherein the actuator is arranged spaced from the sensor array in a third spatial direction transverse to the first and second spatial directions and is designed to be movable relatively to the first and second spatial directions, wherein the actuator is adapted to influence a measurement variable of the sensor elements, wherein the signal of a sensor element represents a degree of overlap of the sensor element by the actuator, comprises the following steps:

Reading the signals of the sensor elements;

Evaluating of the signals using a processing rule to determine the position of the actuator; and

Providing the position as a first coordinate value of the first spatial direction and the second coordinate value of the second spatial direction.

In the step of evaluating, the signals of the sensor elements can be interpolated per row to obtain a value and a coordinate of a signal maximum per row, and the coordinate of the row having the highest value can be selected to obtain the first coordinate value, and the values of the rows can be interpolated to obtain the second coordinate value. By a crisscross evaluation can be found quickly and easily the position of the actuator.

In the step of evaluating per each row, the sensor element can be selected whose signal indicates the greatest degree of overlap in its row, and using the signals of the selected sensor elements, that row can be selected in which the greatest degree of overlap is displayed, and a first interpolation of the signals of the sensor elements of the selected row can be performed to obtain the first coordinate value, and in the range of the first coordinate value, a second interpolation of the signals of the sensor elements of the rows adjacent in the second spatial direction to obtain the second coordinate value. The crisscross evaluation allows finding quickly and easily the position of the actuator.

In the step of evaluating the signals of the sensor elements can be used as references for a lookup table to obtain the position of the actuator from the lookup table. The evaluating by the lookup table allows achieving a sufficiently high accuracy of the position with little computational effort.

In the step of evaluating, the position can be determined using an approximation of values stored in the lookup table. The approximation can increase the accuracy of the position determination.

The present disclosure further provides an apparatus for detecting a position of an actuator of a sensor in two spatial directions, which is adapted to carry out or implement the steps of a variant of the process presented here in corresponding devices. By this embodiment of the disclosure in the form of an apparatus, the object underlying the disclosure can also be resolved quickly and efficiently.

An apparatus can be an electrical device, which processes sensor signals and outputs control signals as a function thereof. The apparatus may comprise one or more suitable interfaces, which can be formed as hardware and/or software. In a hardware configuration, the interfaces can for example be part of an integrated circuit, in which are implemented the functions of the device. The interfaces can also be actual integrated circuits which at least partially consist of discrete components. In a software configuration, the interfaces can be software modules that are available, for example, on a microcontroller in addition to other software modules.

An advantage is also a computer program product with a program code that can be stored on a machine-readable medium such as a semiconductor memory, a hard disk or an optical storage and is used for performing the method for detecting a position of an actuator of a sensor in two spatial directions by one of the above described embodiments when the program is executed on a computer or device.

The disclosure is illustrated by way of example with reference to the accompanying drawings. The figures show:

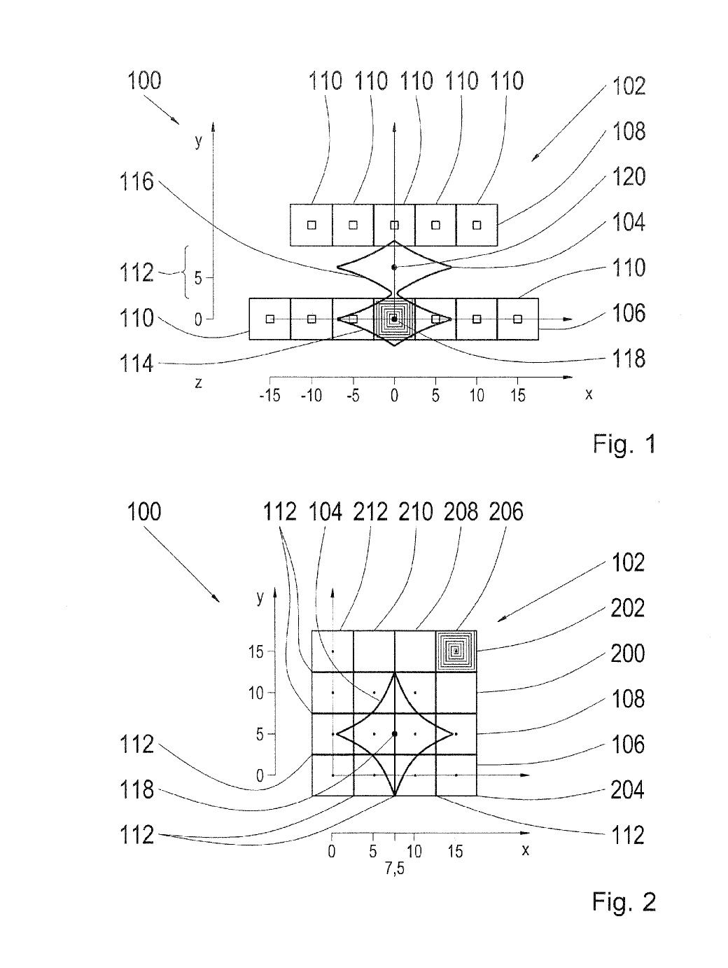

FIG. 1 shows a representation of a sensor for detecting a position in two spatial directions according to an embodiment of the present disclosure;

FIG. 2 shows a representation of a sensor for detecting a position in two spatial directions according to another embodiment of the present disclosure;

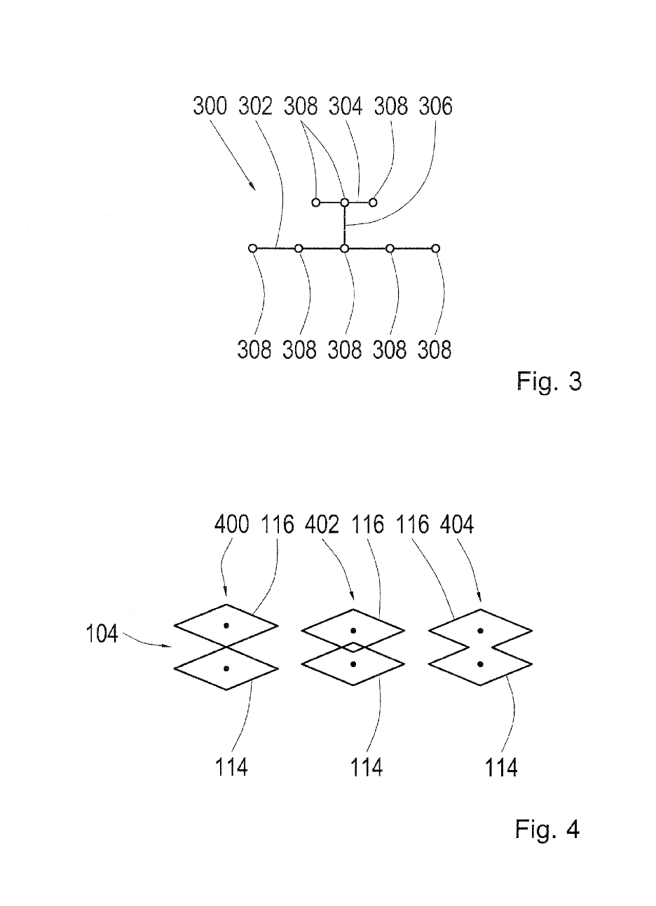

FIG. 3 shows an illustration of a trajectory according to an embodiment of the present disclosure;

FIG. 4 shows representations of optimization stages of an actuator according to an embodiment of the present disclosure;

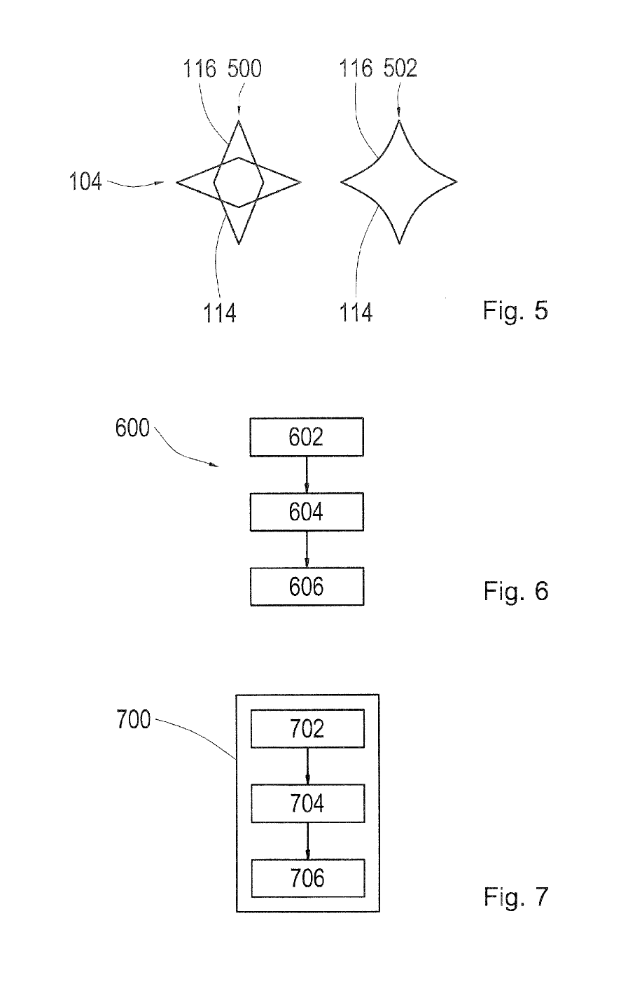

FIG. 5 shows representations of optimization stages of an actuator according to another embodiment of the present disclosure;

FIG. 6 shows a flow chart of a method for detecting a position in two spatial directions according to an embodiment of the present disclosure; and

FIG. 7 shows a block diagram of an apparatus for detecting a position in two spatial directions according to an embodiment of the present disclosure.

In the following description of preferred embodiments of the present disclosure, same or similar reference numerals are used for the elements shown in the various figures and similarly acting. A repeated description of these elements is dispensed with.

For selector lever modules in vehicles with automatic transmission is nowadays needed not only a direction of movement in the forward direction for the automatic speeds, but also a movement in the lateral direction in order to be able to for example switch in a manual path (tiptronic).

This purpose requires a sensor, which can detect the paths and/or angles in two dimensions.

An inductive selector lever module can include a sensor, which is composed of two independent one-dimensional sensor arrays. A mechanical solution can redirect a first direction of movement into the first sensor array and a second direction of movement into the second sensor array. For example, the first direction of movement is a circular path for the manual path (tiptronic), the second direction of movement is a linear path for the tip path (plus, minus).

The approach presented here needs instead of two independent actuators only one two-dimensionally acting actuator. This results in reduced costs because an actuator can be omitted. The two directions of movement need no longer be converted to a cumbersome mechanics of two-dimensional movements. Furthermore, reduced costs result from the elimination of the elaborate mechanics and from the reduced construction costs.

The result is a reduced probability of failure. Unnoticed errors can be prevented, because the actuator for the tip path is omitted and thus can no longer unclip.

There is presented an inductive sensor, which uses only an actuator which can move in both dimensions. For this purpose, a two-dimensional sensor array is used.

In FIGS. 1 and 2 are presented embodiments of inductive sensor units with 2-dimensional position detection. Here, an actuator is used, which can move in both directions. Furthermore, two-dimensional sensor arrays are no longer needed, but only one two-dimensional sensor array. It is further presented in FIG. 6 an enlarged evaluation method that determines from the sensor signals two displacement signals in the X and Y directions and determines from the displacement signals the actuator position derived from these displacement signals.

The actuator can also be composed of several actuators, which are located on a common support. By this arrangement, the distance between the actuating elements can be structurally varied in order to optimize sensor signals. Alternatively or additionally, the sensor coil spacing may be varied.

FIG. 1 shows an illustration of a sensor 100 for detecting a position in two spatial directions x, y according to an embodiment of the present disclosure. The sensor 100 comprises a sensor array 102 and an actuator 104. The sensor array 102 comprises a first row 106 and a second row 108. The rows 106, 108 comprise in a first spatial direction x adjacent sensor elements 110. The second row 108 has fewer sensor elements 110 than the first row 106. The first row 106 has seven square sensor elements 110, which are arranged directly adjacent. The second row 108 has five of the square sensor elements 110. The second row 108 is in the representation positioned in the center next to the first row. The rows 106, 108 are arranged in a third spatial direction z transverse to the first spatial direction x and the second spatial direction y at a distance from the sensor array 102. The actuator 104 is designed movable relative to the sensor array 102 in the first and second spatial directions y x. The actuator 104 is designed to influence a measurement variable of the sensor elements 110, wherein a signal of a sensor element 110 represents a degree of overlap of the sensor element 110 by the actuator 104. Between the first row 106 and second row 108, a clearance 112 is arranged. The actuator 104 includes an electrically conductive material. The sensor elements 110 are formed as sensor coils 110. The actuator 104 is separated by an air gap in the third spatial direction z from the sensor array 102. The actuator 104 is configured to reduce the inductance of the sensor coils 110 by the overlap. The reduced inductance is displayed in the signal. The sensor coils 110 are designed here as a rectangular spiraling conductor path. The sensor coils 110 can be manufactured, for example, by mask etching of a metallized film. The individual coils 110 of the whole sensor 100 can be manufactured from one piece of foil. The actuator 104 has a first sub-area 114 and a second sub-area 116. The first sub-area 114 and the second sub-area 116 are arranged fixed to each other.

Both sub-areas 114, 116 are diamond-shaped. The sides of the diamond shapes are designed slightly concave. The sub-areas 114, 116 are approximately as long as three sensor elements 110. The sub-areas 114, 116 are approximately as wide as a sensor element 110. Here, the diamonds 114, 116 are slightly shorter than three sensor elements 110, wherein the diamonds 114, 116 are slightly wider than a sensor element 110. Both diamonds 114, 116 are arranged in the second spatial direction y side by side and overlap slightly. A first centroid 118 of the first sub-area 114 is spaced from a second centroid 120 of the second sub-area 116. In the illustrated position of the actuator 104, the first centroid 118 is positioned centrally over the front row 106. The second centroid 120 is displaced in the second spatial direction y by half the distance between the rows 106, 108. In the first spatial direction x, the centroids 118, 120 have no displacement. The second centroid 120 is thus centrally positioned in the gap 112.

In an exemplary embodiment not shown, the centroids 118, 120 have an offset in the first spatial direction x.

In an embodiment not shown, the sensor elements 110 of the second row 108 have a displacement in the first spatial direction x compared to the sensor elements 110 of the first row 106.

The offset in the first spatial direction x can improve the measuring accuracy of the sensor 100, because the signals of the sensor elements 110 in the first row 106 have a phase shift to the signals of the sensor elements 110 of the second row.

In an embodiment, the sensor elements have an edge length of five length units, in particular millimeters. Thus, the first row 106 is 35 length units long. The second row 108 is 25 length units long. The gap 112 is five length units wide.

In an embodiment, the actuator 104 is assembled of a plurality of actuation elements 114, 116 which are located on a common carrier. By this arrangement, the distance of the actuation elements 114, 116 can be structurally varied to optimize sensor signals. In addition, the sensor-coil spacing can be varied.

The approach presented here provides a new sensor design of the circuit board, a new actuator 104 and a new mechanism for moving the actuator 104.

FIG. 2 shows an illustration of a sensor 100 for detecting a position in two spatial directions x, y according to another embodiment of the present disclosure. The sensor 100 largely corresponds to the sensor in FIG. 1. The first row 106 and second row 108 each have four sensor elements 110. In addition, the sensor 100 depicted here has a third row 200 and a fourth row 202, each of four adjacent sensor elements 110 in the first spatial direction x. The sensor elements 110 form a matrix of rows 106, 108, 200, 202 and columns 206, 208, 210, 212. In this embodiment, the sensor elements 110 are linearly aligned side by side and one above the other. Between the sensor elements 110 are arranged small interspaces 112. The actuator 104 is configured in this embodiment as a four-beam star with concave edges.

The actuator 104 has here a central centroid 118. The centroid 118 is here centered over the second row 108 and an interspace 112 between the second column 208 and the third column 200.

In the embodiment shown here, the centroid 118 of the actuator 104 is thus in the first spatial direction x at a position of 7.5 length units and five length units in the second spatial direction y. The matrix 204 has an edge length of 20 length units.

The two-dimensional sensor array 102 consists of a matrix of 204 of rows 106, 108, 200, 202 and columns 206, 208, 210, 212. There are a minimum of two rows and two columns necessary. The maximum number is arbitrary. In the illustrated embodiment, the described matrix 204 consists of 4 rows 106, 108, 200, 202 and four columns 206, 208, 210, 212.

FIG. 3 shows an illustration of a trajectory curve 300 according to an embodiment of the present disclosure. The trajectory 300 comprises a first path 302, a second path 304 and a connection path 306. The first path 302 extends in the region of the first row, as shown in FIG. 1. The second path 304 extends in the region of the second row, as shown in FIG. 1. The connection path 306 connects the first path 302 to the second path 304. The connection path 306 is arranged transverse to the first path 302 and the second path 304. In this embodiment, the first path 302 and the second path 304 are centrally aligned with each other. The paths 302, 304 are spaced from each other by the gap, as shown in FIG. 1. The connection path 306 connects, as shown in the embodiment, the center of the first path 302 with the center of the second path 304. The actuator is movable on the first path 302, the second path 304 and the connection path 306. On the first path 302 and the second path 304 are arranged snap-in points 308.

In an embodiment, the path curve 300 with the snap-in points 308 represents a switch diagram of the selector lever for an electronically-controlled transmission for a vehicle. This represents a snap-in point per each switching position of the selector lever. The actuator is coupled to the selector lever. The sensor array is arranged on a housing of the selector lever. Then, the first path 302 represents a main path of a shift gate for the selector lever, while the second path 304 represents a tip path of the shift gate.

In an embodiment not shown, the first path 302 and/or the second path 304 are curved, wherein the sensor array is curved at least in one spatial direction. The selector lever executes a rotational movement. Due to the rotational movement, the actuator describes a section of a circular path as a path curve 300. Then, the sensor array may be embodied curved in order to keep the distance between the actuator and the sensor array within a tolerance range in order to obtain comparable signals from all the sensor elements.

FIG. 4 shows representations of optimization stages 400, 402, 404 of an actuator 104 according to an embodiment of the present disclosure. The actuator 104 essentially corresponds to the actuator in FIG. 1. In the first optimization stage 400, the first optimization sub-area 114 and the second sub-area 116 are aligned with each other so that the diamonds touch each other at the blunt corners. The edges of the diamonds are rectilinear. In the second optimization stage 402, the sub-areas 114, 116 are so aligned with each other that they slightly overlap on the dull corners. The edges are rectilinear. In the third step 404, the optimization sub-areas 114, 116 as shown in FIG. 1 are fused together at the blunt corners. Here the edges are made slightly concave as shown in FIG. 1.

FIG. 5 shows representations of optimization stages 500, 502 of an actuator 104 according to another embodiment of the present disclosure. The actuator 104 here corresponds to the actuator in FIG. 2. In the first optimization stage 500, two diamond-shaped sub-areas 114, 116 are arranged at right angles to each other with matching centroids. The sub-areas 114, 116 overlap in a central region. As in FIG. 2 the sub-areas 114, 116 form a four-beam star. In contrast to the actuator in FIG. 2, the edges are not made concave in the first optimization stage 500. In the second optimization stage 502, the sub-areas 114, 116 are fused. As shown in FIG. 2, the resulting edges are now concave, wherein here the central region, in which the sub-areas 114, 116 overlap, are larger than in the first optimization stage 500.

FIGS. 4 and 5 show actuator forms. With different actuator types, the signal courses can be optimized. An ideally linear displacement signal is obtained when the three normalized values lie exactly on a parabola. This is achieved by a slight curvature of the diamond shape inwards. By varying the spacing of the two diamonds, a center offset can be compensated. By a center offset can be achieved a nonlinearity.

FIG. 6 shows a flow diagram of a method 600 for detecting a position in two spatial directions according to an embodiment of the present disclosure. The method 600 includes a step 602 of reading, a step 604 of evaluating and a step 606 of providing. The method 600 is suitable to detect a position of an actuator of a sensor according to an embodiment of the present disclosure in two spatial directions. The sensor comprises a sensor array and an actuator as shown for example in FIGS. 1 and 2. The sensor array comprises a first row and at least a second row.

The rows have in a first spatial direction two-dimensional sensor elements arranged side by side. The rows are arranged side by side in a second spatial direction transverse to the first spatial direction. The actuator is arranged in a third spatial direction transverse to said first and second spatial directions at a distance from the sensor array. The actuator is carried out movable in the first and second spatial directions relative to the sensor array. The actuator is configured to influence a measurement variable of the sensor elements, wherein the signal of a sensor element represents a degree of overlap of the sensor element by the actuator. In step 602 of reading, the signals from the sensor elements are read. In step 604 of evaluating, the signals are evaluated using a processing rule to determine the position of the actuator. In step 606 of providing, the position is provided as a first coordinate value of the first spatial direction and a second coordinate value of the second spatial direction.

In an exemplary embodiment, in step 604 of evaluating are interpolated the signals of the sensor elements for each row to obtain for each row a value and a coordinate of a signal maximum. The coordinate from the row with the highest value is selected to receive the first coordinate value. The interpolated values of the rows are interpolated to obtain the second coordinate value.

In one embodiment, in step 604 of evaluating is in each row selected the sensor element whose signal indicates the greatest degree of overlap in its row. Using the signals of the selected sensor elements, the row is selected, in which the largest degree of overlap is indicated. A first interpolation of the signals of the sensor elements of the selected row is performed to receive the first coordinate value. In the range of the first coordinate value, a second interpolation of the signals of the sensor elements of the adjacent rows in the second spatial direction is performed in order to obtain the second coordinate value.

In an embodiment, a bell curve is used for interpolating. Thus, the position of the actuator can be determined by the coordinates between the sensor elements.

In an embodiment, in step 604 of evaluating, the signals of the sensor elements are used as references for a lookup table to obtain the position of the actuator from the lookup table.

In an embodiment, the signals of the sensor elements recorded during a calibration are stored in the lookup table. Certain patterns of the signals are stored for certain positions of the actuator. The read signals have similar patterns as the stored patterns. A comparison of the patterns allows concluding the position of the actuator.

In an embodiment, the position is determined in step 604 of evaluating using an approximation of values stored in the lookup table. For example, the values can be interpolated in a linear or polynomial function. Approximating allows in addition to the stored values to obtain intermediate values with which the signals of the sensor elements can be compared.

In an embodiment, the evaluation of the coil signals is carried out in several steps. The following abbreviations are used.

R0, R1, R2, R3 for coil row 0 to coil row 3
S0, S1, S2, S3 for coil column 0 to coil column 3
R0S0 . . . R3 S3 for coil [row 0, column 0] to coil [row 3, column 3]
NMR0 . . . NMR3 for normalized-maximum-row 0 to normalized-maximum-row 3
SR01 for threshold value between coil row 0 and 1
SR12 for threshold value between coil row 1 and 2
SR23 for threshold value between coil row 2 and 3

First, normalization is performed here. In this case, all sensors are normalized, wherein a measured inductance of the sensor coils is converted into a processable signal. By normalizing, the signal of an uninfluenced sensor coil is zero. The stronger the sensor coil is influenced by the actuator, the greater is a signal value of the sensor coil. The normalizing simplifies the further processing of the signals.

Subsequently, a determination of normalized maxima takes place of each coil row. Of each coil row, it is determined the coil which has the maximum normalized value. The maximum normalized values are stored as NMR0, NMR1, NMR2, and NMR3.

Then a path calculation is performed in the Y direction. The path in the Y direction is calculated using the parabolic interpolation with the input values: NMR0 . . . NMR3. The parabolic interpolation is performed using an interpolation function.

Subsequently, a row determination takes place in the Y direction. This is done by comparing the Y path with threshold values. The result is the number in which row the actuator is located (or to which row the actuator is closest). For example

### SR01=2.5 mm

### SR12=7.5 mm

### SR23=12.5 mm

| Condition 1 | Condition 2 | Result |
|---|---|---|
| Y path < 2.5 mm | | Row number = R0 |
| Y path >= 2.5 mm | Y path < 7.5 mm | Row number = R1 |
| Y path >= 7.5 mm | Y path < 12.5 mm | Row number = R2 |
| Y path >= 12.5 mm | | Row number = R3 |

Then is performed the path calculation in the X direction. Based on the previously determined row number, the parabolic interpolation with the following values is activated.

| Row | | | | |
|---|---|---|---|---|
| number | Value 0 | Value 1 | Value 2 | Value 3 |
| R0 | R0S0 | R0S1 | R0S2 | R0S3 |
| R1 | R1S0 | R1S1 | R1S2 | R1S3 |
| R2 | R2S0 | R2S1 | R2S2 | R2S3 |
| R3 | R3S0 | R3S1 | R3S2 | R3S3 |

The result is saved as the path in the X direction.

Subsequently is done a position determination in the X direction. The comparison of the X and Y paths with switch thresholds can generate switch positions.

The calculation is illustrated by a numerical example. The sensor array and the actuator position are shown in FIG. 2.

Sensor voltages in mV are read in.

| | S0 | S1 | S2 | S3 |
|---|---|---|---|---|
| R3 | 3500 | 3500 | 3500 | 3500 |
| R2 | 3500 | 3000 | 3000 | 3500 |
| R1 | 3300 | 1500 | 1500 | 3300 |
| R0 | 3500 | 3000 | 3000 | 3500 |

From this result the normalized values in mV.

| | S0 | S1 | S2 | S3 |
|---|---|---|---|---|
| R3 | 0 | 0 | 0 | 0 |
| R2 | 0 | 500 | 500 | 0 |
| R1 | 200 | 2000 | 2000 | 200 |
| R0 | 0 | 500 | 500 | 0 |

The normalized maxima of the coil rows in mV result as

| | | |
|---|---|---|
| NMR3 | | 0 |
| NMR2 | y3 | 500 |
| NMR1 | y2 | 2000 |
| NMR0 | y1 | 500 |

The following equation is used for the path calculation in the Y direction:

$${X}_{s} = d ( {x}_{2} + \frac{( {y}_{3} - {y}_{1} )}{2 ( 2 {y}_{2} - {y}_{1} - {y}_{3} )} )$$

where d is the coil distance in mm (=5 mm),
x2 is the NMR index of the highest value (=1)
and Xs is the Y path.

With number values there results:

$${X}_{s} = 5 mm ( 1 + \frac{( 500 - 500 )}{2 ( 2 \cdot 2000 - 500 - 500 )} ) = 5 mm$$

On this is based the row determination in the y direction, where

| Y path | Condition 1 | Condition 2 | Result |
|---|---|---|---|
| 5 mm | Y path >= 2.5 mm | Y path < 7.5 mm | Row number = R1 |

Subsequently is performed the path calculation in the X direction in mm.

Normalized values of the coil row 1 in mV

| | S0 | S1 | S2 | S3 |
|---|---|---|---|---|
| R1 | 200 | 2000 | 2000 | 200 |
| | y1 | y2 | y3 | |

${X}_{s} = d ( {X}_{s} + \frac{( {y}_{2} - {y}_{1} )}{2 ( 2 {y}_{2} - {y}_{1} - {y}_{0} )} )$

d: Coil distance in mm (=5 mm)
x2: NMR index of the highest value (=1)
Xs: X path

$${X}_{s} = 5 mm ( 1 + \frac{( 2000 - 200 )}{2 ( 2 \cdot 2000 - 200 - 2000 )} ) = 7 , 5 mm$$

Since the interpolation functions require three values, the third missing value is set to 0 at only two values.

If only two coils are actuated, the parabolic interpolation can proceed as follows.

With three coils, the following calculation would result.

$${X}_{s} = d ( {x}_{2} + \frac{( {y}_{3} - {y}_{1} )}{2 ( 2 {y}_{2} - {y}_{1} - {y}_{3} )} )$$

d: coil distance in mm

$${X}_{s} = 25 mm ( 8 + \frac{( 256 - 256 )}{2 ( 2 \cdot 768 - 256 - 256 )} ) = 200 mm$$

With P1 (7/256); P2 (8/768); P3 (9/256); d=25 mm

If now the coil is only available with P1, the following values result: P1 (7/0); P2 (8/768); P3 (9/256); d=25 mm

$${X}_{s} = 25 mm ( 8 + \frac{( 256 - 0 )}{2 ( 2 \cdot 768 - 0 - 256 )} ) = 200 , 5 mm$$

Due to the missing coil, the result differs only slightly from the reference value.

FIG. 7 shows a block diagram of an apparatus 700 for detecting a position in two spatial directions according to an embodiment of the present disclosure. The apparatus 700 comprises means 702 for reading, means 704 for evaluating and means 706 for providing. The apparatus 700 is adapted to detect a position of an actuator of a sensor according to an embodiment of the present disclosure in two spatial directions. In this case, the sensor, as shown for example in FIGS. 1 and 2, comprises a sensor array and an actuator. The sensor array has a first row and at least a second row. The rows have in a first spatial direction two-dimensional sensor elements arranged side by side. The rows are arranged side by side in a second spatial direction transverse to the first spatial direction. The actuator is arranged in a third spatial direction transverse to said first and second spatial directions at a distance from the sensor array. The actuator is designed movable in the first and second spatial directions relatively to the sensor array. The actuator is configured to influence a measurement variable of the sensor elements, wherein the signal of a sensor element represents a degree of overlap of the sensor element by the actuator. The device 702 for reading is designed to read the signals of the sensor elements. The device 704 for evaluating is designed to evaluate the signals using a processing rule to determine the position of the actuator. The device 706 for providing is designed to provide the location as a first coordinate value of the first spatial direction and the second coordinate value of the second spatial direction.

The embodiments described and shown in the figures are selected only by way of example. Different exemplary embodiments can be combined completely or with respect to individual characteristics. An embodiment can also be supplemented by features of another embodiment.

Furthermore, process steps according to the disclosure can be repeated as well as executed in a sequence other than the sequence described.

If an embodiment includes an “and/or” linkage between a first feature and a second feature, this can be read so that the embodiment comprises both the first feature and the second feature according to one embodiment and either only the first feature or the second feature according to a further embodiment.

### REFERENCE NUMERALS

X First spatial direction
Y Second spatial direction
Z Third spatial direction
100 Sensor
102 Sensor array
104 Actuator
106 First row
108 Second row
110 Sensor element
112 Interspace
114 First sub-area
116 Second sub-area
118 First centroid
120 Second centroid
200 Third row
202 Fourth row
204 Matrix
206 First column
208 Second column
210 Third column
212 Fourth column
300 Path curve
302 First path
304 Second path
306 Connection path
308 Snap-in point
400 First optimization stage
402 Second optimization stage
404 Third optimization stage
500 First optimization stage
502 Second optimization stage
600 Method for detecting a position
602 Step of reading in
604 Step of evaluating
606 Step of providing
700 Device for detecting a position
702 Device for reading in
704 Device for evaluating
706 Device for providing

1. A sensor for detecting a position in two spatial directions (x, y), wherein the sensor comprises:
a sensor array with a first row and a second row, the rows comprising in a first spatial direction (x) adjacently arranged sensor elements and the rows are arranged side by side in a second spatial direction (y) transverse to the first spatial direction (x); and
an actuator arranged in a third spatial direction (z) transverse to the first spatial direction (x) and the second spatial direction (y), wherein the actuator is spaced from the sensor array and is designed movable in the first spatial direction (x) and the second spatial direction (y) relative to the sensor array, wherein the actuator is adapted to influence a measurement variable of the sensor elements, wherein a signal of a sensor element represents a degree of overlap of the sensor element by the actuator.

2. The sensor according to claim 1, wherein between the first row and the second row is arranged an intermediate space.

3. The sensor according to claim 1, wherein the second row has fewer sensor elements than the first row.

4. The sensor according to claim 1, wherein the actuator is movable on a first path, a second path and a connecting path, wherein the first path at least partially extends in the area of the first row, the second path at least partially extends in the area of the second row and the connecting path connects the first path to the second path.

5. The sensor according to claim 4, wherein the first path or the second path are curved, wherein the sensor array is curved at least in one spatial direction (z, x, y).

6. The sensor according to claim 1, wherein the actuator comprises an electrically conductive material or the sensor elements are formed as sensor coils, whereby the actuator is separated by an air gap from the sensor array and is adapted to reduce the inductance of the sensor coils based the overlap and the reduced inductance is displayed in the signal.

7. The sensor according to claim 1, wherein the actuator comprises a first sub-area and a second sub-area, wherein the first sub-area and the second sub-area are arranged fixed to each other and a first centroid of the first sub-area is arranged spaced from a second centroid of the second sub-area.

8. The sensor according to claim 1, wherein the sensor array comprises in the second spatial direction (y) alongside the second row at least one further row of adjacently arranged sensor elements in the first spatial direction (x), wherein the rows form a matrix.

9. A method for detecting a position of an actuator of a sensor in two spatial directions (x, y), wherein the sensor includes a sensor array and an actuator, wherein the sensor array comprises a first row and a second row that are arranged next to one another in the second spatial direction (y) transverse to the first spatial direction (x), wherein the rows have in a first spatial direction (x) adjacent planar sensor elements, wherein the actuator is arranged in a third spatial direction (z) transverse to the first spatial direction (x) and the second spatial direction (y) at a distance from the sensor array and is designed movable in the first spatial direction (x) and the second spatial direction (y) relative to the sensor array, wherein the actuator is adapted to influence a measurement variable of the sensor elements, wherein a signal of the sensor element represents a degree of overlap of the sensor element by the actuator, wherein the method comprises the steps of:
reading in the signals of the sensor elements;
evaluating the signals using a processing rule to determine the position of the actuator; and
providing the position as a first coordinate value of the first spatial direction (x) and a second coordinate value of the second spatial direction (y).

10. The method according to claim 9, wherein in the step of evaluating, the signals of the sensor elements are interpolated for each row to obtain a value of a signal maximum for each row and the row with the highest value is selected to obtain the first coordinate, and the values of the rows are interpolated in order to obtain the second coordinate value.

11. The method according to claim 9, wherein in the step of evaluating, the signal of the sensor element selected indicates the greatest degree of overlap in its rows and using the signals of the selected sensor elements, the row is selected in which the largest degree of overlap appears, and a first interpolation of the signals of the sensor elements of the selected row is performed to obtain the first coordinate value, and in the range of the first coordinate value a second interpolation of the signals of the sensor elements is performed of the adjacent rows in the second spatial direction (y) to obtain the second coordinate value.

12. The method according to claim 9, wherein in the step of evaluating, the signals of the sensor elements are used as references for a lookup table to obtain the position of the actuator from the lookup table.

13. The method according to claim 12, wherein in the step of evaluating the position is determined using an approximation of the values stored in the lookup table.

14. An apparatus for detecting a position of an actuator of a sensor in two spatial directions (x, y), which is configured to perform the steps of a method according to claim 9.

15. A computer program product with a program code for performing the method according to claim 9 when the program product is executed on a device.

16. The sensor according to claim 4, wherein the first path and the second path are curved, and wherein the sensor array is curved at least in one spatial direction (z, x, y).

17. The sensor according to claim 1, wherein the actuator comprises an electrically conductive material and the sensor elements are formed as sensor coils, whereby the actuator is separated by an air gap from the sensor array and is adapted to reduce the inductance of the sensor coils based the overlap and the reduced inductance is displayed in the signal.

18. The sensor according to claim 7, wherein the first sub-area and the second sub-area are diamond shaped, wherein the sides of the diamonds are concave.

19. The sensor according to claim 1, wherein the actuator is comprised of several actuators located on a common support.

20. The sensor according to claim 4, wherein the first path and the second path include a plurality of snap-in points, wherein the snap-in points represent a switch diagram of a selector lever for an electronically-controlled transmission for a vehicle and each snap-in point represents a switching position of the selector lever.
